(19) United States
(12) Patent Application Publication
(10) Pub. No.: US 2012/0092656 A1
(43) Pub. Date: Apr. 19, 2012

(54) Defect Inspection Method and Defect Inspection Apparatus

(76) Inventors: Toshiyuki Nakao, Yokohama (JP); Shigenobu Maruyama, Oiso (JP); Yuta Urano, Yokohama (JP); Toshihiko Nakata, Hiratsuka (JP)

(21) Appl. No.: 13/322,935

(22) PCT Filed: Jun. 28, 2010
(86) PCT No.: PCT/JP2010/004249

§ 371 Date: Nov. 29, 2011

(30) Foreign Application Priority Data
Jul. 1, 2009 (JP) 2009-156507

(51) Int. Cl. G01N 21/88

(52) U.S. Cl. 356/237.3

(57) ABSTRACT

Provided is a method for inspecting a defect on a surface of a sample, the method including the steps of comparing a haze signal distribution with a predetermined light intensity distribution to calculate pixel shift amounts of detection signals; and adding up shift corrected detection signals to detect a defect.

### BACKGROUND OF THE INVENTION

The present invention relates to a surface defect inspection method and inspection apparatus for inspecting a micro-defect present on a surface of a sample with high accuracy and at high speed.

In a manufacturing line for, for example, semiconductor substrates and thin film substrates, inspection of defects present on the surface of the semiconductor substrate or the thin film substrate is performed to maintain and improve product yield. A known technique is “to irradiate a wafer surface with a laser beam focused to several tens of micrometers (μm) and to focus and detect light scattered from a defect, thereby detecting a defect that may measure several tens of nanometers (nm) to several micrometers (μm) or more,” as disclosed in patent document 1 (JP-A-09-304289) and patent document 2 (JP-A-2000-162141).

Another known technique, as disclosed in patent document 3 (JP-A-2007-240512), is “to linearly illuminate a wafer supported by a rotary stage that makes a translational movement a plurality of times and, using an imaging optical system, forming light scattered from an illuminated area on a line sensor, thereby adding up scattered light signals generated from an identical area”.

### PATENT DOCUMENT

Patent Document 1: JP-A-09-304289

Patent Document 2: JP-A-2000-162141

Patent Document 3: JP-A-2007-240512

### SUMMARY OF THE INVENTION

With the trend towards miniaturization in LSI wiring rapidly growing in recent years, the size of the defect to be detected is approaching a limit of detection by optical inspection. According to the Roadmap for Semiconductors, mass production of 36-nm-node LSI devices will be started in 2012 and inspection apparatuses for pattern-less wafers are required to offer a capacity of detecting a defect having a size of about DRAM half pitch. In order to follow the trend in semiconductors towards miniaturization, detection sensitivity of the inspection apparatuses should be improved intermittently. The term “detects” as used herein refer to particles or crystal originated particle (COP) affixed to the wafer and scratches produced through grinding.

The techniques disclosed in patent documents 1 and 2 pose problems of, for example, damage to the wafer by the increased laser power and a reduced throughput as a result of a reduced area to be inspected per unit time. Specifically, it is known that a magnitude I of scattered light emanated when the defect is illuminated with a laser has a relation of I∝D̂6, where D denotes a particle diameter of the defect. Because of the increasingly miniature size of the defect to be detected with the increasing trend towards miniaturization in LSI wiring in recent years, the intensity of scattered light obtained is becoming feeble. This calls for an increase in the scattered light emanated from a miniature defect. Increasing a laser power is one possible method of increasing the intensity of the scattered light emanated from the defect. This method, however, increases a surface temperature of an area on the wafer irradiated with the laser, which can damage the wafer. Another method of increasing the intensity of the scattered light to be detected is to elongate an irradiation time, which, however, invites a reduced throughput because of the reduced area to be inspected per unit time.

The technique disclosed in patent document 3 has a problem of reduced detection accuracy. Specifically, the wafer is rotated at speeds as high as several thousands of revolutions per minute (rpm) during the inspection, so that variations in height of the wafer relative to a direction perpendicular to the wafer are produced by vibration or convection. Variations in height of the wafer are also produced by irregularities on the surface of the wafer. If the wafer is irradiated with the laser obliquely, the variations in height of the wafer vary a specific spot on the wafer irradiated with the laser. This produces a difference between an area to be irradiated and an area actually irradiated, which creates deviation in a relationship between the area on the wafer irradiated with the laser and an area detected with a line sensor. As a result, the variations in height of the wafer during the inspection collapse a correspondence between pixels of the line sensor that detects scattered light from a substantially identical area. This disables addition of signals of the identical area (this problem will hereinafter be referred to as “detection pixel shift” or simply as “pixel shift”), so that unfortunately, the method of adding scattered light obtained by illuminating the same defect on the wafer surface a plurality of times results in reduced defect inspection accuracy.

Representative aspects of the present invention disclosed in this application will be briefly described as follows.

(1) A method for inspecting a defect on a surface of a sample, including the steps of: irradiating a predetermined area on a sample surface with illumination light plural times, with the sample surface being formed with an elliptically shaped illumination area upon irradiation; receiving light scattered from the sample surface in each irradiation sequence using a detector having a plurality of pixels, the detector being disposed corresponding to the illumination area and capable of detecting scattered light with the plurality of pixels; converting the scattered light from the sample surface in each time of the irradiation into a corresponding detection signal in each time of the irradiation; extracting from each of the detection signals obtained in the converting step a haze signal obtained from scattered light which is emanated from irregularities on the sample surface irradiated with the illumination light; calculating a pixel shift amount for each of the detection signals by comparing a distribution of a plurality of haze signals extracted from the extracting step with a predetermined light intensity distribution; correcting the detection signals using the pixel shift amount calculated for each of the detection signals; and detecting a defect from the detection signal by adding up the detection signals corrected in the correcting step.

(2) The defect inspection method according to (1), wherein: in the step of calculating the pixel shift amount, the distribution of the multiple haze signals is compared with a reference light intensity distribution that is a distribution of haze signals obtained when the illumination light is irradiated in an assumed condition of no variations in a direction perpendicular to the sample surface.

The aspect of the present invention can provide a defect inspection method and a defect inspection apparatus for inspecting a defect present on the surface of a sample with high accuracy.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1A is a diagram showing a configuration of a defect inspection apparatus according to a first embodiment of the present invention.

FIG. 1B is a side elevational view showing the defect inspection apparatus according to the first embodiment of the present invention.

FIG. 2 is a configuration diagram showing a detection optical system of the defect inspection apparatus according to the first embodiment of the present invention.

FIG. 3A is a side elevational view showing a spatial positional relationship between an illumination area and a line sensor.

FIG. 3B is a plan view showing a positional relationship of a detection range on a sample surface.

FIG. 4A is an illustration for illustrating a positional relationship between the illumination area on the sample surface and the sensor detection range when the pixel shift does not occur.

FIG. 4B is an illustration for illustrating a positional relationship between the illumination area on the sample surface and the sensor detection range when the pixel shift occurs.

FIG. 4C is a diagram for illustrating a magnitude of the pixel shift and a direction of the pixel shift.

FIG. 5 is a graph for illustrating a detection signal.

FIG. 6 is a diagram for illustrating a process for pattern matching using a haze signal.

FIG. 7 is an illustration for illustrating a defect map and a haze map.

FIG. 8 is a diagram showing a modified example of the defect inspection apparatus according to the first embodiment of the present invention.

FIG. 9 is a typical flow chart showing an inspection process in a defect inspection method according to a first embodiment of the present invention.

FIG. 10 is a configuration diagram showing an illumination optical system that illuminates such that illuminating light exhibits a non-Gaussian distribution on the sample surface in the defect inspection apparatus according to the first embodiment of the present invention.

FIG. 11 is a configuration diagram showing an illumination optical system that illuminates such that illuminating light exhibits a non-Gaussian distribution on the sample surface in the defect inspection apparatus according to a second embodiment of the present invention.

FIG. 12 is a side elevational view showing the defect inspection apparatus according to the second embodiment of the present invention.

FIG. 13 is a side elevational view for illustrating a positional relationship between the sample surface and the illumination area when the height of the sample varies.

FIG. 14 is a plan view showing how the illumination area on the sample surface varies when the height of the sample varies.

FIG. 15 is a side elevational view for illustrating specularly reflected light and a direction in which the specularly reflected light travels when the height of the sample varies.

FIG. 16 is a typical flow chart showing an inspection process in a defect inspection method according to the second embodiment of the present invention.

FIG. 17 is a plan view for illustrating a positional relationship between the illumination area and the detection area when an area sensor is used on the sample surface.

FIG. 18 is a plan view showing a defect inspection apparatus according to a third embodiment of the present invention.

FIG. 19A is a plan view for illustrating a first positional relationship between the illumination area on the sample surface and the sensor detection range.

FIG. 19B is a plan view for illustrating a second positional relationship between the illumination area on the sample surface and the sensor detection range.

FIG. 20A is a plan view for illustrating a third positional relationship between the illumination area on the sample surface and the sensor detection range.

FIG. 20B is a plan view for illustrating a fourth positional relationship between the illumination area on the sample surface and the sensor detection range.

### MODES FOR CARRYING OUT THE INVENTION

### First Embodiment

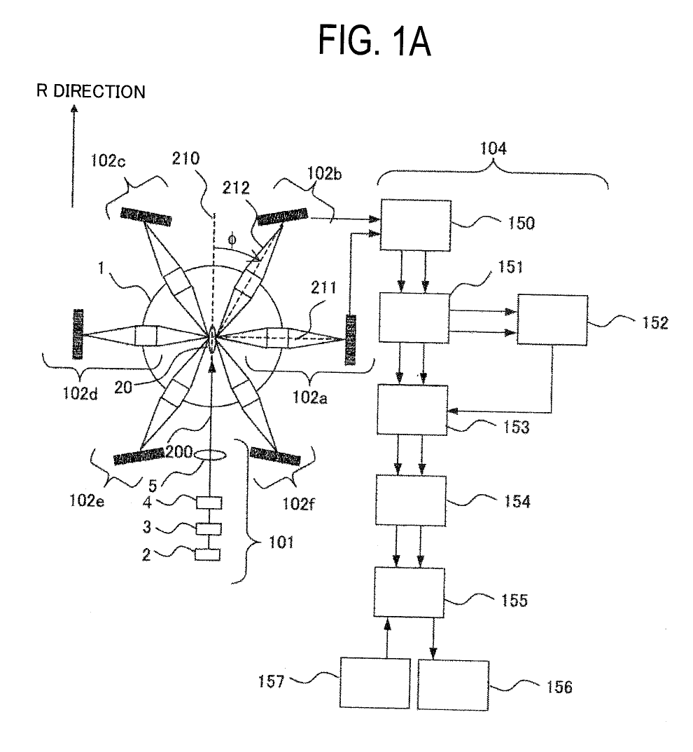

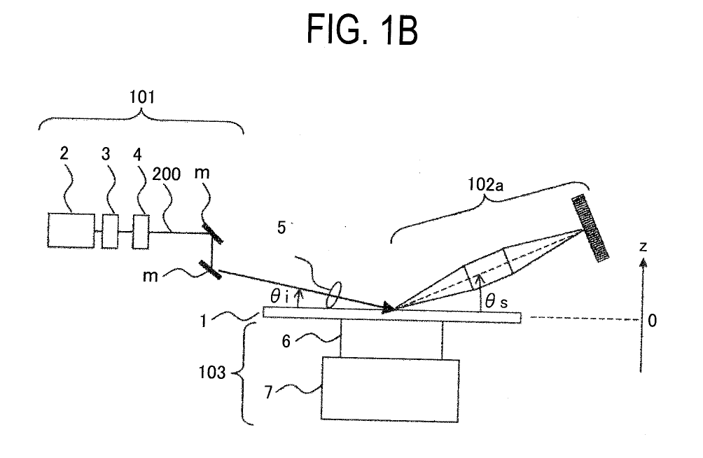

A defect inspection apparatus according to an embodiment of the present invention will be described with reference to FIGS. 1A and 1B. FIG. 1A is a plan view showing the defect inspection apparatus according to the embodiment of the present invention and FIG. 1B is a side elevational view showing the same. The defect inspection apparatus shown in FIGS. 1A and 1B includes a wafer 1, an illumination optical system 101, detection optical systems 102a to 102f, a wafer stage 103, and a signal processing system 104.

(Illumination Optical System 101)

The illumination optical system 101 includes a laser light source 2, a beam expander 3, a polarizing element 4, a mirror m, and a condenser lens 5. A laser beam 200 emitted from the laser light source 2 is adjusted to a desired beam diameter by the beam expander 3 and converted to a desired polarized state by the polarizing element 4. The resultant laser beam changes the optical path by reflected by a pair of mirrors m and is applied by the condenser lens 5 onto an area to be inspected on the wafer 1 to be inspected at an elevation angle θi.

In order to detect a micro-defect near the wafer surface, preferably, the laser light source 2 is a type that oscillates a short-wavelength (a wavelength of 355 nm or less) laser beam that is hard to penetrate into the wafer. The illumination elevation angle θi is preferably 10 degrees from the wafer surface. An illumination area 20 is substantially elliptical in shape on the wafer surface, measurements are, for example, substantially 1000 μm in a direction of a major axis and substantially 20 μm in a direction of a minor axis. The beam expander 3 is an anamorphic optical system, including plural prisms. The beam expander 3 changes a beam diameter only in one direction in a plane perpendicular to an optical axis and performs spot illumination or linear shaped illumination on the wafer 1 using the condenser lens 5.

(Detection Optical Systems 102a to 102f)

The detection optical systems 102a to 102f are disposed in multiple azimuth directions φ and directions of elevation angles θi relative to the wafer surface, detecting light scattered from the illumination area 20 on the wafer. The detection optical systems 102a to 102f are disposed substantially at intervals of 60 degrees in terms of the azimuth direction relative to the wafer surface, so that the azimuth angles φ at which the detection optical systems 102a to 102f are disposed are 30, 90, 150, 210, 270, and 330 degrees, respectively.

In relation to the azimuth directions φ in which the multiple detection optical systems are disposed, the detection optical system 102a is disposed in an azimuth direction that is such that an angle formed between an optical axis 211 of the detection optical system 102a and a longitudinal direction 210 of the illumination area 20 is substantially 90 degrees.

In relation to the azimuth directions φ in which the multiple detection optical systems are disposed, if at least one detection optical system is disposed in an azimuth direction such that the angle formed between the optical axis 211 of the detection optical system and the longitudinal direction 210 of the illumination area 20 is substantially 90 degrees, then no restrictions are imposed on the azimuth directions φ in which remaining detection optical systems are disposed. In FIG. 1, the detection optical system 102a corresponds to the detection optical system in which the longitudinal direction 210 of the illumination area 20 and the optical axis 211 of the detection optical system are mutually orthogonal to each other. This arrangement is made in order to calculate coordinates of a signal based on scattered light detected with the detection optical system 102a when a magnitude of pixel shift and a direction of pixel shift are to be detected through pattern matching performed using a signal based on roughness scattered light emanated from surface roughness of the wafer (hereinafter referred to as a haze signal). A reason for the pixel shift will be given later.

In addition, a detection elevation angle es is 30 degrees from the wafer surface and a numerical aperture is 0.3. The same applies also to the detection optical systems 102b to 102f, each being disposed at a detection elevation angle of 30 degrees from the wafer surface and having a numerical aperture of 0.3.

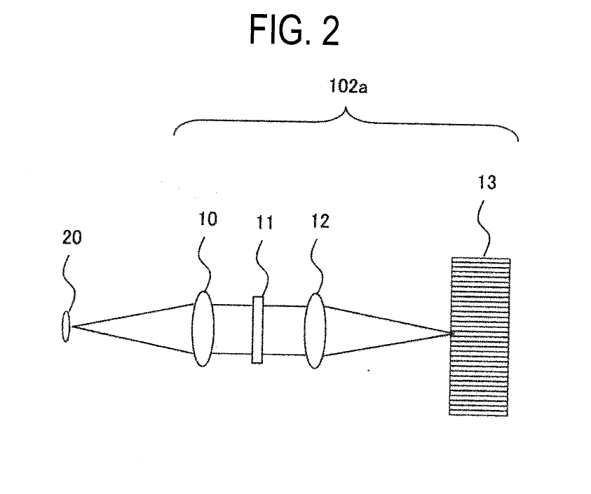

Each of the detection optical systems 102a to 102f shares substantially similar arrangements. FIG. 2 shows the arrangements of a detection optical system in detail. The detection optical system 102a includes an objective lens 10, a polarizing element 11, an imaging lens 12, and a line sensor 13. The illumination area 20 and the line sensor 13 are disposed at positions conjugate with each other, so that scattered light from the illumination area 20 is imaged on each of a plurality of pixels of the line sensor 13. Disposing the line sensor of each of the detection optical systems 102a and 102d so as to extend substantially in parallel with the longitudinal direction 210 of the illumination area 20 results in the line sensor being disposed at a position conjugate with the illumination area 20.

An optical magnification of the objective lens 10 is a reduction system of 0.1×. The polarizing element 11 may, for example, be a polarizing filer or a polarized beam splitter (PBS). The polarizing element 11 reduces the roughness scattered light through polarizing detection, thereby enabling detection of an even more miniature defect. Further, the polarizing element 11 is rotatable about the optical axis of the detection optical system and is also removable. Model NSPFU-30C from Sigma Koki Co., Ltd. may, for example, be used for the polarizing filter and model PBSW-10-350 from Sigma Koki Co., Ltd. may, for example, be used for the PBS. For the line sensor 13, model S3923-256Q from Hamamatsu Photonics K.K. may, for example, be used. The model S3924-256Q has 256 pixels, a pixel pitch of 25 μm, and a pixel height of 0.5 mm.

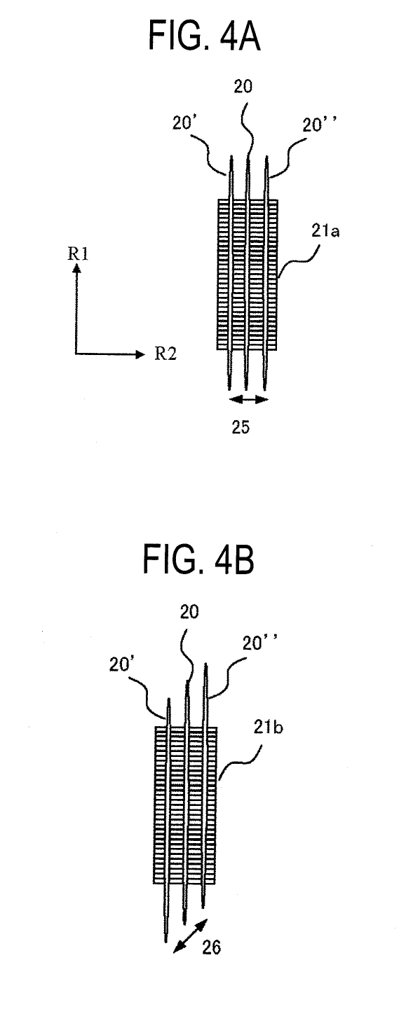

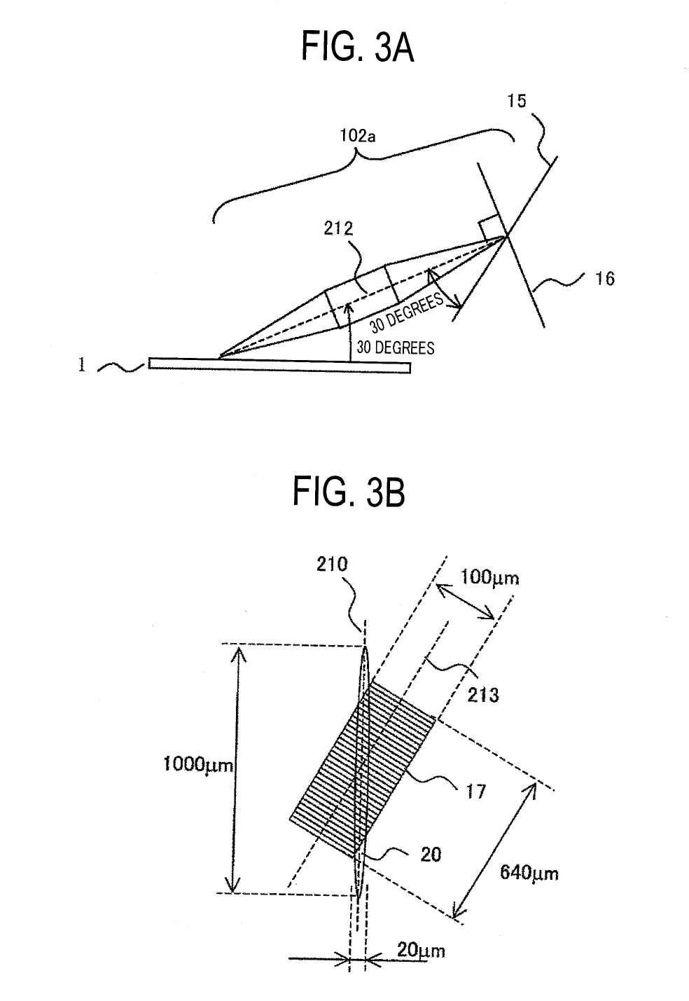

The detection optical system 102b has an optical axis 212 that forms an angle of about 30 degrees relative to the longitudinal direction 210 of the illumination area 20 and has a detection elevation angle of 30 degrees. In case that an image is formed at an optical magnification of 1×, the image is formed on a plane 15 inclined at 30 degrees relative to the optical axis as shown in FIG. 3A. By using a reduction ratio in the detection optical system, the inclined image can be corrected and an image can be formed on a plane substantially perpendicular to the optical axis 212. Since the optical magnification of the objective lens 10 is the reduction system of 0.1×, the inclined image is corrected and an image is formed on a plane 16 substantially perpendicular to the optical axis 212. A general optical magnification depends on the magnification of the imaging lens 12 and the optical magnification of the detection optical systems 102a to 102f is generally 10×.

When the line sensor 13 of the detection optical system 102b is disposed at a position in the plane 16 perpendicular to the optical axis and in parallel with the wafer 1, the illumination area 20 on the surface of the wafer 1 and a detection range 17 of the line sensor 13 are in a positional relationship as shown in FIG. 3B, so that the longitudinal direction 210 of the illumination area 20 and a direction 213 in which pixels of the line sensor are arrayed form an angle of 30 degrees. Under this condition, all scattered light rays emanated from the illumination area 20 cannot be captured. All scattered light rays emanated from the illumination area 20 can, however, be captured by rotating the line sensor about the optical axis 212. Since the angle formed between the longitudinal direction 210 of the illumination area 20 and the direction 213 in which the line sensor pixels are arrayed is 30 degrees, rotation through the same angle of 30 degrees substantially cancels the angle formed between the longitudinal direction 210 of the illumination area 20 and the direction 213 in which the line sensor pixels are arrayed to 0 degrees. All scattered light rays emanated from the illumination area 20 on the wafer 1 can thereby be captured and an image can be formed on the line sensor.

For the detection optical systems 102c, 102e, and 102f, the angle formed between the longitudinal direction 210 of the illumination area 20 and the direction 213 in which the line sensor pixels are arrayed varies depending on the detection azimuth. The line sensor is therefore rotated about the optical axis according to the specific detection azimuth concerned, so that all scattered light rays emanated from the illumination area 20 are captured and an image is formed on the line sensor.

(Wafer Stage 103)

Referring to FIG. 1B showing an example, the wafer stage 103 includes a Z stage (not shown), a rotational stage 6, and a translational stage 7. Specifically, the Z stage includes a chuck for holding the wafer 1 and performs height control. The rotational stage 6 rotates the wafer. The translational stage 7 moves the wafer 1 in an R direction. The wafer stage 103 allows the illumination area 20 to spirally scan the entire surface of the wafer 1 by performing rotational scanning and translational scanning. Height of the wafer surface in a stationary state is here defined as z=0 and a perpendicularly upward direction is defined as a positive direction.

(Signal Processing System 104)

The signal processing system 104 includes an analog circuit 150, an A/D converting section 151, a pixel shift detecting section 152, a pixel shift correcting section 153, a signal adding and defect determining section 154, a CPU 155, a map output section 156, and an input section 157.

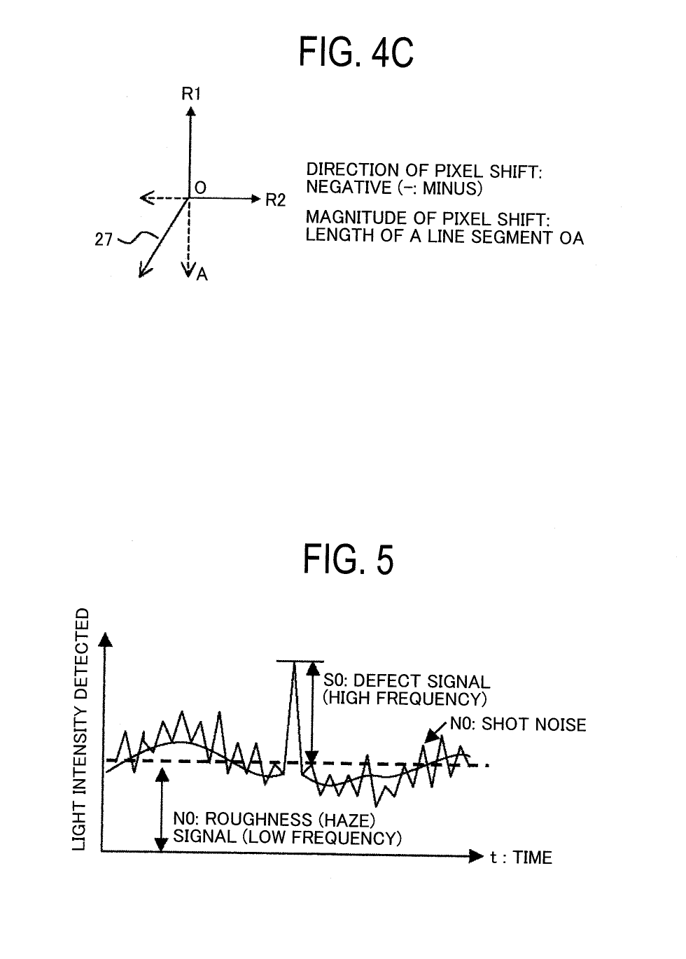

A reason why the pixel shift occurs from variations in height of the wafer will be described with reference to FIGS. 4A and 4B. The terms “variations in height of the wafer” as used herein refer to variations in height of the wafer in a vertical direction occurring from rotation of the wafer at high speeds during inspection or irregularities on the wafer surface. The term “pixel shift” refers to shift of pixels between an area on the wafer irradiated with the laser and an area detected with the line sensor, the shift occurring from a difference between an area to be irradiated and an area actually irradiated occurring based on the variations in height of the wafer. FIG. 4A shows a positional relationship between a detection range 21a of the line sensor on the surface of the wafer 1 and the illumination area 20 as viewed from a position at which the detection optical system 102a is disposed. FIG. 4B shows a positional relationship between a detection range 21b of the line sensor on the surface of the wafer 1 and the illumination area 20 as viewed from a position at which the detection optical system 102b is disposed. The direction in which the line sensor pixels are arrayed is defined as an R1 direction and the direction in height of the pixels is defined as an R2 direction. R1 and R2 are orthogonal to each other.

When no variations in height of the wafer occur, the illumination area 20 on the wafer is irradiated in both FIGS. 4A and 4B. The positional relationship between the illumination area and the detection range 21a/21b is the same and, under this condition, an initial adjustment is made to bring the detection range of the two line sensors into a substantially identical area. Specifically, in the initial adjustment, correspondence between scattered light emanated from a substantially identical area and a pixel to detect the scattered light is established. During inspection, signals based on the scattered light are simply added up according to the correspondence.

A case with variations in height of the wafer will be described below. When the wafer surface height z=0, the illumination area 20 and the line sensor 13 are in focus. When the height of the wafer surface varies, however, the illumination area 20 and the line sensor 13 are out of focus, resulting in the imaging position onto the line sensor of the scattered light emanated from the illumination area 20 being varied. Let “h” be any given constant. FIGS. 4A and 4B show that, if rotation of the wafer 1 at high speed results in the wafer surface height deviating in a z direction by +h μm, the illumination area 20 deviates to a position of an illumination area 20′ and, if the rotation of the wafer 1 at high speed results in the wafer surface height deviating in the z direction by −h μm, the illumination area 20 deviates to a position of an illumination area 20″.

In the example shown in FIG. 4A, a direction 25 in which the illumination area 20 deviates is only in the R2 direction that is the pixel height direction, in which case no pixel shift occurs. In the example shown in FIG. 4B, on the other hand, the direction in which the illumination area 20 deviates is a direction 26, so that the illumination area 20 deviates not only in the R2 direction, but also in the R1 direction. Pixel shift occurs because of the illumination area 20 deviating also in the R1 direction. Pixel shift here means that the variations in height of the wafer during inspection collapse a correspondence between pixels of the line sensor detecting the scattered light from substantially an identical area. This causes a difference between the area to be illuminated and the area actually illuminated. If detection signals are added up as they are without the pixel shift being corrected, addition of signals of the same area is disabled and an effect of signal amplification through addition of signals is reduced, resulting in reduced detection accuracy.

It is known that the directions 25, 26 in which the illumination area 20 deviates as a result of variations in height of the wafer vary according to the detection azimuth cp. It is also known that the magnitude with which the illumination area 20 deviates varies according to the detection elevation angle φ, the detection azimuth φ, and the magnitude of variations in height of the wafer. The direction in which the illumination area 20 deviates will hereinafter be regarded as a vector; having components of R1 and R2, a sign of the R1 component is defined as a direction of pixel shift, an absolute value of the R1 component is defined as a magnitude of pixel shift, and a combination of the direction of pixel shift and the magnitude of pixel shift are defined as a pixel shift amount. In the case shown in FIG. 4C, assuming a direction 27 in which the illumination area 20 deviates, the direction of pixel shift is negative (−) and the magnitude of pixel shift is the length of a line segment OA.

In the present invention, when pixel shift occurs with a resultant collapse of the correspondence between pixels that detect the scattered light from a substantially identical area, a technique described below is employed to detect the direction of pixel shift and the magnitude of pixel shift and to correct coordinates of the detection signals. The correspondence between pixels is thereby corrected and the effect of signal amplification is maximized, so that detection sensitivity can be enhanced.

(Processing in the Analog Circuit 150 and the A/D Converting Section 151)

The illumination optical system 101 shown in FIG. 1A irradiates the surface of the wafer with illumination light, the line sensor 13 that receives light scattered from the surface of the wafer generates an electric signal corresponding to the intensity of the received light, and the generated electric signal is guided to the analog circuit 150. Processing performed by the analog circuit 150 will be described below.

On receipt of the scattered light from the illumination area 20, the line sensor 13 outputs a detection signal as shown in FIG. 5. Roughness scattered light emanated from roughness on the wafer surface that represents irregularities on the wafer surface is generated at all times during a laser irradiation period and detected as low-frequency undulation like a roughness signal N₀ (<several kHz). When the roughness signal (haze signal) N₀ enters the line sensor and undergoes photoelectric conversion, a shot noise N₀ that represents a random variation is generated and simultaneously detected. Defect scattered light S₀ that is emanated from a defect, on the other hand, is generated in a pulse form for a short period of time during which the illumination area 20 with an illumination width of 20 μm moves across the position at which a defect is present. As indicated as a defect signal S₀, the defect scattered light S₀ has a frequency higher than that of the roughness signal N₀ (>several kHz). Specifically, when the detection signal shown in FIG. 5 is guided to the analog circuit 150, a high-pass filter (passing frequencies: >several kHz) may be applied to the detection signal to extract the defect signal, and a low-pass filter (passing frequencies: <several kHz) may be applied to the detection signal to extract the haze signal.

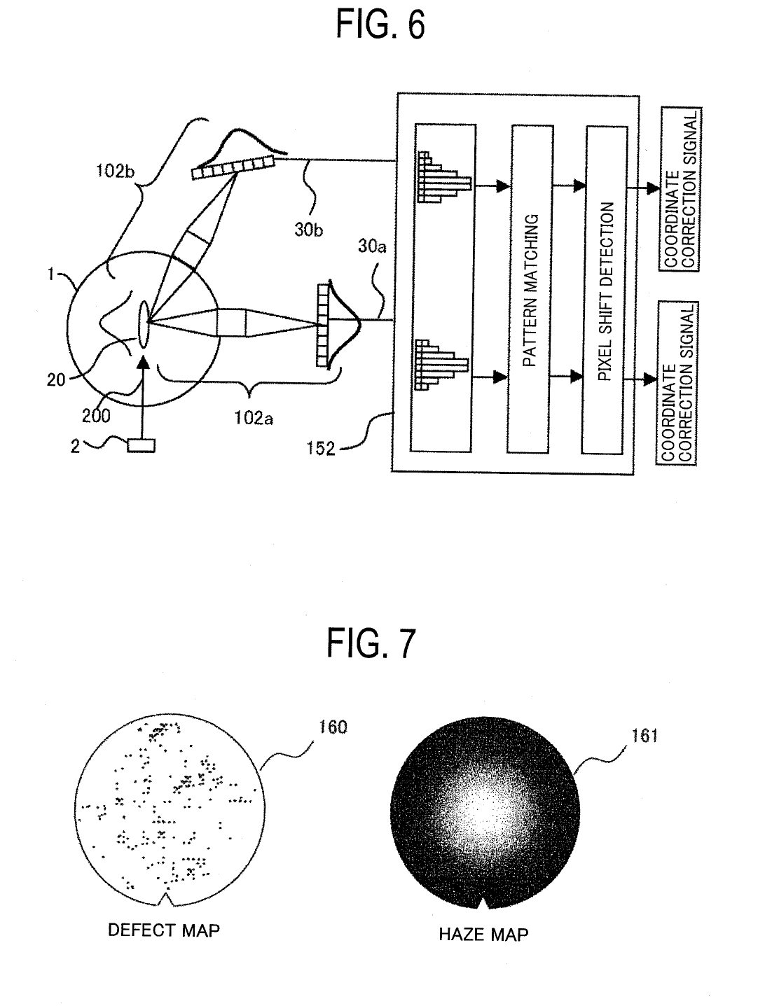

Thus, the high-pass filter is applied to the defect signal as the electric signal generated based on the defect scattered light detected by the line sensor 13, while the low-pass filter is applied to the haze signal as the electric signal generated based on the roughness scattered light detected by the line sensor 13. This permits processing of the defect signal as separated from the haze signal, and vice versa. A signal that has undergone the above-described filtering process is converted to a corresponding digital signal by the A/D converting section 151 at a sampling pitch of several MHz or more. The haze signal that has converted to a corresponding digital signal is input to the pixel shift detecting section 152, so that the magnitude and the direction of pixel shift caused by variations in height of the wafer can be detected. A method for detecting the magnitude and the direction of pixel shift will be described with reference to FIG. 6.

(Processing in the Pixel Shift Detecting Section 152)

FIG. 6 shows the wafer 1, the laser light source 2, a laser beam 200, the illumination area 20, the detection optical systems 102a, 102b, and the pixel shift detecting section 152. In case, for example, the illumination area 20 is illuminated with a laser beam with a Gaussian distribution, roughness scattered light corresponding roughly to the Gaussian distribution is detected by each pixel of the line sensors of the detection optical systems 102a, 102b. Since a haze signal that has undergone low-pass filtering in the analog circuit 150 is guided to the pixel shift detecting section 152, haze signals 30a, 30b with a Gaussian distribution form based on the scattered light received by the detection optical systems 102a, 102b are input. In Gaussian distribution, a maximum value of distribution values is a median of distribution. In the initial adjustment, therefore, correspondence between the illumination area 20 and each pixel of the line sensor can be established by adjusting such that a center of the illumination area 20 coincides with a center pixel of the line sensor. If pixel shift occurs as a result of wafer variations, a peak value of the Gaussian distribution of the haze signal no longer matches with the center pixel of the line sensor. The pixel shift detecting section 152 thus performs pattern matching using the distributions of the haze signals 30a and 30b to thereby detect the pixel shift amount of, for example, the magnitude of pixel shift and the direction of pixel shift.

In this case, the pixel shift amount is to be detected as a difference between a position of a pixel at which the Gaussian distribution of the haze signal assumes a peak value (maximum value) and the center pixel of the line sensor. The magnitude and the direction of shift may be detected as follows. Specifically, using the intensity of light detected by each pixel of each line sensor, coordinates of a center of gravity of the illumination area 20 are calculated and, using the coordinates of the center of gravity, the magnitude and the direction of shift are detected. Alternatively, the position of the pixel at which the haze signal detected by the line sensor assumes the maximum value is used instead of the center pixel of the line sensor. In this time, since pixel shift does not occur, even with variations in height of the wafer, in the haze signal based on the scattered light received by the detection optical system 102a. The optical axis 211 of the detection optical system 102a is disposed at a position substantially orthogonal to the longitudinal direction 210 of the illumination area 20. Thus, the haze signal can serve as a reference for detecting the magnitude of pixel shift and the direction of pixel shift. Alternatively, during the initial adjustment, the pixel that detects scattered light emanated from a substantially central of the illumination area 20 is recorded as a template and this template may be used for detecting the magnitude and the direction of pixel shift.

For each of detection signals of all other detection optical systems, the magnitude of pixel shift and the direction of pixel shift as the pixel shift amount are calculated to thereby generate a pixel shift correction signal, so that the pixel shift correction signal is output to the pixel shift correcting section 153.

A specific example of the pixel shift correction signal will be given below. Assume a coordinate system having two axes of (R, θ). Consider a case in which variations in height of the wafer occur at θ=θ00 (any constant) and a detection signal of the detection optical system 102b detects pixel shift of “+5 μm in the R direction” through pattern matching. The pixel shift correction signal in this case is as described below. For the detection signal of each of all pixels of the detection optical system 102b, the coordinate in the R direction is corrected only by “−5 μm” at the coordinates of θ=θ00.

In FIG. 6, a description has been made for a case in which the pixel shift correction signal is generated through pattern matching using only the haze signals based on the scattered light received by the detection optical systems 102a and 102b. It may be possible for a pixel shift correction signal be generated for each detection signal by guiding to the pixel shift detecting section 152 haze signals obtained from all detection optical systems using a line sensor. In this case, the pixel shift correction signal is generated for each of all haze signals to thereby correct pixel shift of the detection signal, which allows the detection signals to be added up accurately for detection of a defect.

(Processing at the Pixel Shift Correcting Section 153 to the Input Section 157 and the Map Output Section 156)

The pixel shift correcting section 153 receives a defect signal and a haze signal from the A/D converting section 151 and a pixel shift correction signal from the pixel shift detecting section 152. The defect signal and the haze signal are subjected to correct the pixel shift in the signal distribution based on the pixel shift correction signal. The signal for which pixel shift is corrected is guided to the signal adding and defect determining section 154, at which signals of the same pixel are added up. Further, based on the added signal, threshold processing is performed to determine and classify the defect and calculate defect dimensions, and haze processing is performed through level determination.

The map output section 156 then displays a defect map 160 and a haze map 161 shown in FIG. 7 via the CPU 155. The defect map 160 is displayed based on a defect type, a defect size, and detection coordinates read during the inspection and the haze map 161 is displayed based on a haze signal level and the detection coordinates read during the inspection. In addition, the input section 157 includes a user interface for allowing a user to set a recipe. The detection optical systems disposed at multiple azimuths as described above achieve the signal amplification effect, if a defect inspection is conducted by adding up all signals based on the scattered light received by the multiple detection optical systems, which enables detection of defects with high accuracy. In addition to intensifying the effect of signal amplification by signal addition, a sensitivity with which defects are to be detected can be improved by selecting the detection optical system to be used or weighting to use the detection signal of each detection optical system. The roughness scattered light has a dependency on azimuth angle which is corresponding to roughness of the wafer surface. Take, for example, a Si wafer having an extremely smooth surface. With such a wafer, the roughness scattered light tends to occur more intensely in the direction from which the laser beam 200 enters, specifically, the azimuth direction in which the detection optical systems 102e and 102f exist. With a wafer on which an aluminum thin film is deposited and has severe surface roughness, the roughness scattered light tends to occur more intensely in the direction along which the laser beam 200 travels, specifically, in the azimuth direction in which the detection optical systems 102b and 102c exist. The defect detection sensitivity can be improved by using only the detection signal detected by the detection optical system existing at the azimuth at which a weak roughness scattered light is emanated, or by multiplying the detection signal by gain of weight that is variable according to the intensity of the roughness scattered light.

Described in the above has been a method for detecting the pixel shift amount, including the magnitude of pixel shift and the direction of pixel shift, by performing pattern matching using the distributions of the haze signals 30a and 30b with reference to the detection optical system 102a. For the reference haze signal distribution, a reference light intensity distribution is established in advance representing a distribution of haze signals obtained when the illumination light is irradiated in an assumed condition of no variations in a direction perpendicular to the wafer surface, instead of using the detection optical system 102a. The pixel shift amount may then be calculated with reference to the reference light intensity distribution. In this case, only at least one detection optical system is required and use of the previously established reference light intensity distribution for pattern matching reference allows pixel shift arising from physical positional deviation involving, for example, the illumination optical system and the stage, to be taken into consideration, so that the defect detection sensitivity can be enhanced. In this manner, the pixel shift amount can be calculated by comparing the previously set light intensity distribution with the distribution of detected haze signals.

Referring back to FIGS. 1A and 1B, laser illumination is performed from a direction extending in parallel with the longitudinal direction 210 of illumination. However, there is no need to have the longitudinal direction 210 of illumination substantially the same as the direction of laser illumination and illumination may be performed from a different azimuth direction. An advantage of illumination from a different direction lies in improved performance in classifying defects having a directional property in defect shapes, such as a scratch. Light scattered from a defect, such as the COP, which is substantially symmetrical relative to the azimuth direction has no dependency on azimuth angle. Such scattered light tends to occur substantially evenly in all azimuth directions. Light scattered from a defect, such as a scratch, which is not symmetrical with respect to the azimuth direction, on the other hand, has a dependency on azimuth angle. In addition, the light scattered from the scratch also has a characteristic in azimuth that depends on an azimuth from which the illumination enters. Defect classifying accuracy and dimension calculating accuracy can therefore be enhanced by actively varying the illumination direction and comparing a signal present in one azimuth direction with another present in another azimuth direction.

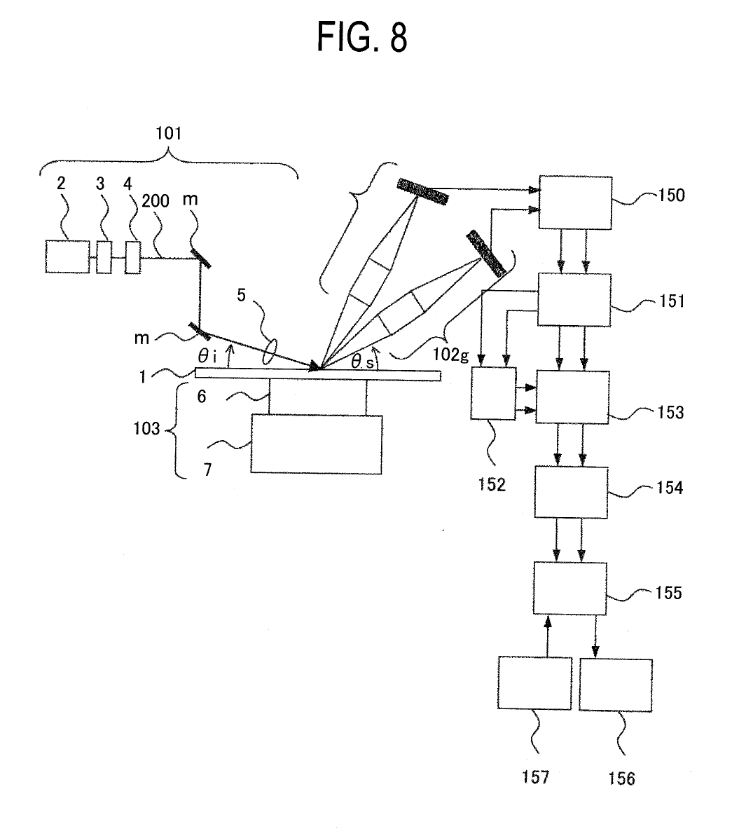

FIG. 8 is a typical side elevational view showing the example shown in FIGS. 1A and 1B. The arrangement shown in FIG. 8 includes an oblique illumination optical system 101, a low angle detection optical system 102g, and a high angle detection optical system 102h. Specifically, the oblique illumination optical system 101 provides illumination from a low elevation angle θi. The low angle detection optical system 102g detects scattered light at a low elevation angle θs. The high angle detection optical system 102h detects scattered light at an elevation angle higher than that of the low angle detection optical system 102g. With respect to the oblique illumination optical system, a vertical illumination optical system that illuminates the wafer from a substantially perpendicular direction may exist (not shown).

At this time, detection signals based on the scattered light received by the low angle detection optical system 102g and the high angle detection optical system 102h, respectively, having different elevation angles relative to the wafer surface are input to the analog circuit 150. Thereafter, the same processing is performed as that of the signal processing system of FIG. 1A.

An embodiment including an illumination optical system and a plurality of detection optical systems having different elevation angles has been described above. The defect inspection apparatus having such an arrangement offers the following two major advantages. A first advantage is as follows. Specifically, for a particle adhered on the wafer, illumination using the oblique illumination optical system provides a greater scattering cross-sectional area relative to the particle than the vertical illumination optical system does, so that the intensity of light scattered from the particle is greater to thereby enable detection of even finer micro-defects. In addition, light scattered from a defect with a size of several tens of nm scatters more intensely on the low elevation angle side and light scattered from a defect with a size of one hundred nm or more scatters more intensely on the high elevation angle side. The range of dimensions of defects to be detected can therefore be expanded by letting the low angle detection optical system detect micro-defects and the high angle detection optical system detect relatively large defects. For COP, scratches, and other defects concave to the wafer, illumination by the vertical illumination optical system provides a greater scattering cross-sectional area, so that sensitivity to concave defects can be enhanced. Further, light scattered from a concave defect scatters more intensely onto the high elevation angle side. Use of the high angle detection optical system can therefore enhance detection sensitivity even more. As described above, the distribution of intensity and elevation angle characteristic of the light scattered from the defect is different by the type (e.g., particle, COP, scratches) and size of the defect. Defect classifying accuracy and defect dimension calculating accuracy can therefore be enhanced by combining and comparing signals of different illumination directions and detection directions.

As a second effect, relating to the method for processing the detection signal detected by each of multiple detection optical systems disposed at multiple azimuths and multiple elevation angle directions, addition and averaging are performed for each detection signal. The addition increases the intensity of light detected, which improves detection sensitivity. The averaging expands the size to be detected within a dynamic range of the sensor, which enlarges the dynamic range.

The embodiment has been described for the laser light source 2 that is a type oscillating a wavelength of 355 nm. However, a laser light source of a type oscillating a visible, ultraviolet, or vacuum ultraviolet laser beam may be used. The embodiment has also been described for the illumination area 20 that is substantially elliptical in shape on the wafer surface, measuring substantially 1000 μm in a direction of a major axis and substantially 20 μm in a direction of a minor axis. The illumination area 20 does not, however, necessarily have an elliptical shape or limitations in terms of its dimensions.

The embodiment has been described with reference to FIGS. 1A and 1B in which there are six detection optical systems disposed at different azimuth directions φ. However, the number of detection optical systems is not limited to six. Further, no restrictions are imposed on the detection azimuth θ and detection elevation angle θs.

The embodiment has been described for the objective lens 10 having an optical magnification of 0.1×; however, the magnification is not limited. The embodiment has been described for a case in which the optical magnification of the detection optical systems 102a to 102f is generally 10×, which, however, is not the only possible arrangement. The numerical aperture of the detection optical systems 102a to 102f is not necessarily substantially the same in all detection optical systems, or each of the detection optical systems 102a to 102f does not necessarily have a unique numerical aperture.

The illumination optical system 101 has also been described so as to include the beam expander 3 and the condenser lens 5 for illuminating. A cylindrical lens may be employed to perform linear shaped illumination. If a single cylindrical lens is used, the wafer can be illuminated linearly without having to change the beam diameter in one direction only within a plane perpendicular to the optical axis by using an anamorphic optical system. This eliminates the need for the beam expander 3, effective in reducing the number of parts used in the optical system. The line sensor 13 is used to receive scattered light for photoelectric conversion. A multi-anode photomultiplier tube, a TV camera, a CCD camera, a photodiode, a linear sensor, or a high sensitivity image sensor combining an image intensifier with any of the foregoing devices may be used. For example, use of a two-dimensional sensor enables simultaneous inspection of a wide area. The line sensor has been described to have 256 pixels and a pixel pitch of 25 μm. No restrictions are, however, imposed on the number of pixels and the size of each pixel.

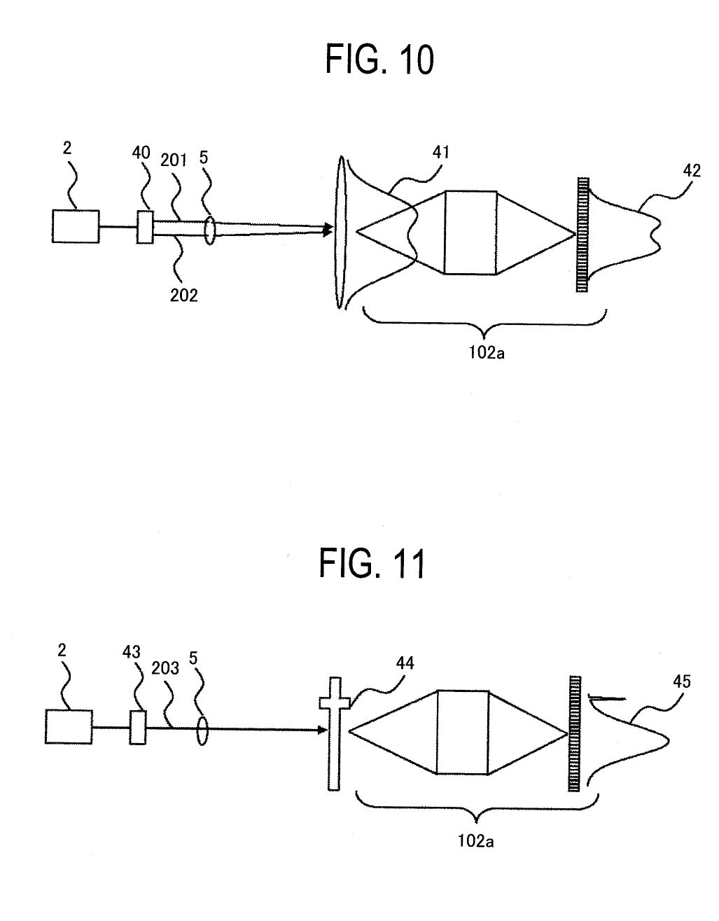

The method for detecting the magnitude of pixel shift and the direction of pixel shift in the pixel shift detecting section 152 has been described for a case in which the illumination intensity distribution is a Gaussian distribution; however, the illumination intensity distribution is not limited to the Gaussian distribution. For example, referring to FIG. 10, the laser beam 200 is separated into a laser beam 201 and a laser beam 202 using a birefringent element 40, such as a Wollaston prism, and adjacent areas are illuminated with the two separated laser beams. This achieves illumination having an illuminance distribution 41 through superimposition of the Gaussian distributions. In this case, each of the pixels of the line sensor detects a haze signal 42 having two peak values. Referring to FIG. 11, intervention of a mask 43 allows a laser beam 203 having desired illuminance distribution and beam shape to be generated. The wafer is then illuminated through reduction with the adjusted laser beam 203, so that modulated illumination 44 can be performed. At this time, the line sensor detects a haze signal 45 having a sharper peak value than in illumination with the Gaussian distribution.

Further, the illumination 44 may still be performed through modulation using a diffractive optical element (DOE), without using the mask 43. Use of the DOE enables generation of modulated illumination with desired illuminance distribution and shape by simply replacing the condenser lens 5 with the DOE, without having to use the mask 43. This is advantageous in that the space for mounting the illumination optical system can be reduced.

As described above, by performing illumination having an illuminance distribution and a beam shape different from the Gaussian distribution, a haze signal more characteristic than with the Gaussian distribution is detected and pattern matching is performed based thereon. This enables even more accurate pattern matching, so that the magnitude of pixel shift and the direction of pixel shift can be detected even more accurately.

Each of the low angle detection optical system 102g and the high angle detection optical system 102h includes a plurality of low angle detection optical systems 102g and a plurality of high angle detection optical systems 102h, respectively, each being disposed at a unique azimuth direction φ. However, these low angle detection optical systems 102g and high angle detection optical systems 102h are not necessarily disposed at substantially the same elevation angle, or each does not necessarily have a unique elevation angle. The numerical aperture of the low angle detection optical systems 102g and the high angle detection optical systems 102h are not necessarily substantially the same in all detection optical systems, or each of the detection optical systems 102g, 102h does not necessarily have a unique numerical aperture.

The embodiment has been described for an example in which the pixel shift detecting section 152 generates a pixel shift correction signal and the pixel shift correcting section 153 corrects the coordinates of the detection signal based on the pixel shift correction signal. However, the following processing may, instead, be performed.

Specifically, if the magnitude of pixel shift is equal to, or more than, a predetermined value when the pixel shift detecting section 152 detects the magnitude of pixel shift and the direction of pixel shift, an adding pixel correction signal is generated. In case that the magnitude of pixel shift is equal to, or more than, 2.5 μm that corresponds to one pixel of the line sensor on the wafer surface, a signal is generated to shift the adding pixel by one pixel. If the magnitude of pixel shift is equal to, or more than, 5.0 μm that corresponds to two pixels, then a signal is generated to shift the adding pixel by two pixels. The magnitude of adding pixel shift added to the direction of pixel shift is referred to as the adding pixel correction signal that is output from the pixel shift detecting section 152.

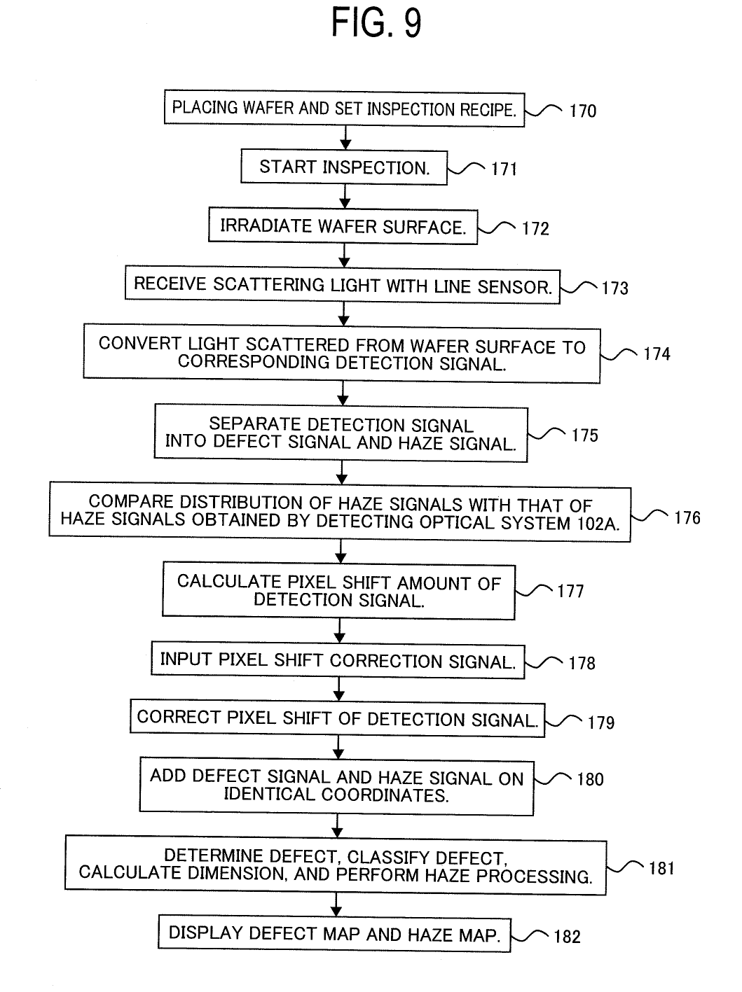

When the pixel shift detecting section 152 generates an adding pixel correction signal, the pixel shift correcting section 153 does not correct coordinates. The signal adding and defect determining section changes pixels to be added to thereby perform signal addition based on the adding pixel correction signal. A defect detection process will be described below with reference to FIG. 9.

The wafer 1 is first placed on the stage and an inspection recipe is set (step 170). The inspection is started (step 171) and the surface of the wafer is irradiated with light (step 172). Light scattered from the wafer surface is received by the line sensor (step 173) and the light scattered from the wafer surface is converted to a corresponding detection signal (step 174). The converted detection signal is separated into a defect signal obtained from light scattered from a defect on the wafer surface and a haze signal obtained from light scattered from irregularities on the wafer surface (step 175). A distribution of the haze signal is compared with a light intensity distribution obtained by the detection optical system 102a (step 176). A pixel shift amount, including the magnitude of pixel shift and the direction of pixel shift, of the detection signal is calculated (step 177). A pixel shift correction signal is transmitted based on the pixel shift amount obtained through calculation (step 178). The detection signal is corrected for pixel shift based on the pixel shift correction signal (step 179). The signal adding and defect determining section 154 adds up signals of identical coordinates (step 180). The defect is then determined and classified, dimensions are calculated, and haze processing is performed based on the added signal (step 181). A defect map and a haze map are displayed (step 182).

It is here noted that, when the signals of the identical coordinates are added, a plurality of detection signals based on scattered light obtained by irradiating a substantially identical area on the wafer surface a plurality of times may be added, or a plurality of detection signals based on scattered light received by the detection optical systems disposed at different azimuth directions relative to the wafer surface may be added. When a plurality of detection signals based on scattered light received by the detection optical systems disposed at different azimuth directions relative to the wafer surface are to be added, the identical area on the wafer surface has only to be irradiated at least once. In the defect inspection apparatus according to the embodiment of the present invention, although the illumination area on the wafer surface irradiated by the illumination optical system is fixed, the detection optical system detects the scattered light while the stage that supports the wafer makes rotational and translational movements. This results in the positional relationship between the wafer surface and the illumination area changing spirally. For this reason, “irradiating a substantially identical area on the wafer surface a plurality of times” refers to irradiating any area (to be referred to as “a predetermined area”) including a specific portion on the wafer surface a plurality of times. Specifically, it is not required that a completely identical area be irradiated at each sequence and the area to be irradiated may be changed as long as the predetermined area including a specific portion is irradiated. In addition, in order to irradiate the predetermined area on the wafer surface a plurality of times, it is required that a distance over which the stage makes a translational movement while the wafer is rotated one complete turn be shorter than the length of the major axis (longitudinal direction) of the illumination area. When all detection signals of all sequences are added up, a significant signal amplification effect can be obtained. Furthermore, the defect detection may be made using the detection signal in which the pixel shift is corrected for a single detection signal. In this case, the pixel shift amount is corrected and the position of the defect can be accurately detected.

With reference to FIG. 9, a method has been described in which the pixel shift amount, including the magnitude of pixel shift and the direction of pixel shift of the detection signal, is calculated by comparing the distribution of the haze signal with the light intensity distribution obtained by the detection optical system 102a. Instead of steps 176 and 177, the method may include a step in which the pixel shift amount is calculated by comparing the distribution of the haze signal with a predetermined light intensity distribution, such as a predetermined reference light intensity distribution. The term “reference light intensity distribution” as herein used refers to a light intensity distribution obtained on the assumption that there are no variations involved in a Z-axis direction relative to the wafer surface. As an example, a detection signal obtained based on scattered light detected with the wafer not subject to rotational or translational movement may be used. Another example is to assume a light intensity distribution in which the light intensity takes its maximum value at the center of a plurality of pixels. In addition, the predetermined light intensity distribution may be one other than the reference light intensity distribution, as long as such a distribution corresponds to one obtained on the assumption that there are no variations involved in the Z-axis direction relative to the wafer surface, such as the detection optical system 102a and the reference light intensity distribution.

### Second Embodiment

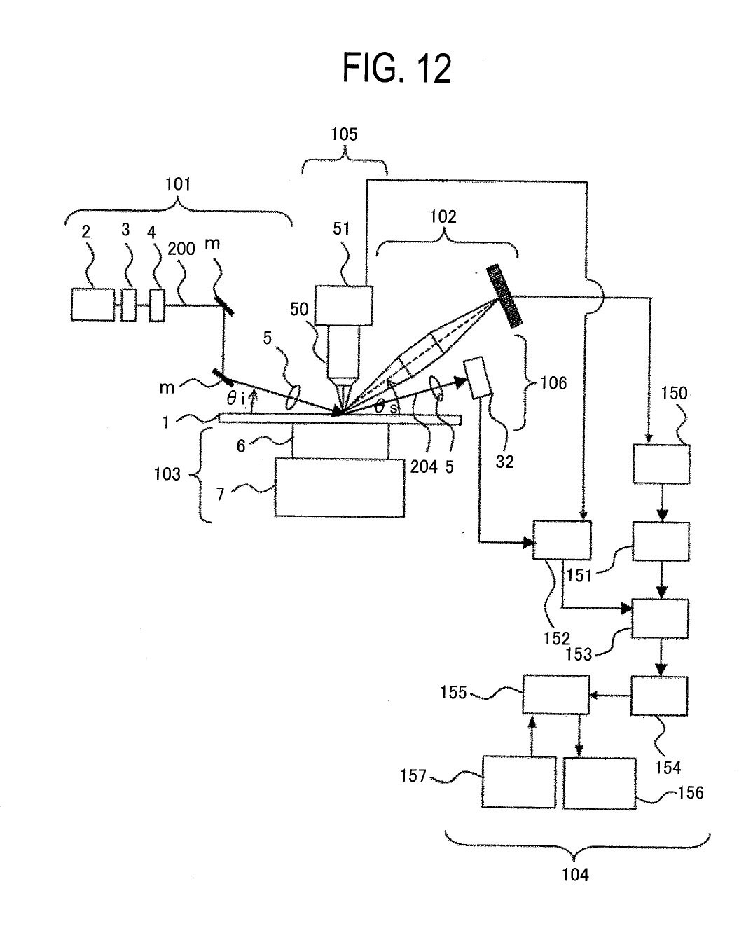

A second embodiment of the present invention will be described below with reference to FIG. 12. The defect inspection apparatus shown in FIG. 12 includes a wafer 1, an illumination optical system 101, a detection optical system 102, a wafer stage 103, a signal processing system 104, an illumination area observing optical system 105, and a regularly reflected light observing optical system 106.

Detailed arrangements of the illumination optical system 101, the detection optical system 102, and the wafer stage 103 are substantially the same as those shown in FIG. 1 and descriptions therefor will be omitted.

The second embodiment is characterized in that at least one of the illumination area observing optical system 105 and the regularly reflected light observing optical system 106 shown below detects a magnitude of variations in height of the wafer and a direction of variations in height of the wafer using the detection signal based on the scattered light received. The second embodiment is further characterized in that a pixel shift detecting section 152 calculates the magnitude of pixel shift and the direction of pixel shift based on the magnitude and direction of variations in height of the wafer, and a pixel shift correcting section 153 corrects the pixel shift. Methods for the detection performed by the illumination area observing optical system 105 and the regularly reflected light observing optical system 106 will be described in detail below.

(Processing in the Illumination Area Observing Optical System 105 and the Regularly Reflected Light Observing Optical System 106)

(1) The illumination area observing optical system 105 is used to detect the magnitude and direction of positional deviation of the illumination area, and variations in height of the wafer.

(2) The regularly reflected light observing optical system 106 is used to detect the magnitude and direction of positional deviation of the regularly reflected light, and variations in height of the wafer.

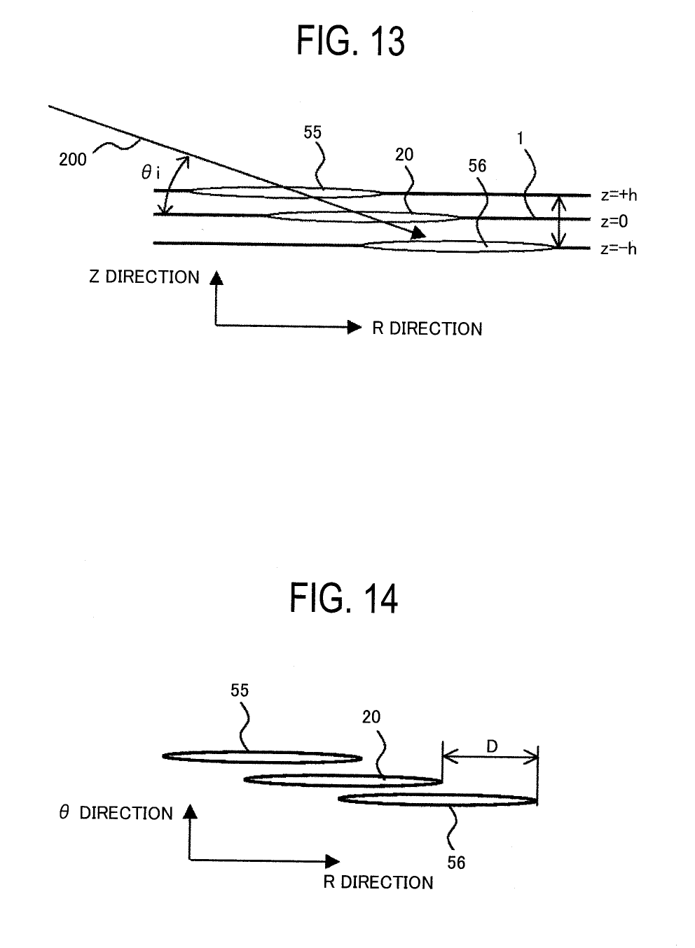

The technique of (1) above will be described below with reference to FIGS. 13 and 14.

FIG. 13 is an enlarged side elevational view showing an area on which an illumination area 20 is created as a result of a laser beam 200 entering the wafer 1 at an angle of incidence θi in FIG. 12. The wafer surface exists at a height of z=0 when no variations occur in the height of the wafer. When the wafer surface height varies by +h μm, the position at which the laser beam 200 and the wafer 1 intersect changes, so that an illumination area 55 is created on the wafer. Similarly, when the wafer surface height varies by −h μm, the position at which the laser beam 200 and the wafer 1 intersect changes, so that an illumination area 56 is created on the wafer. Specifically, variations in the height of the wafer change the position of the illumination area created on the wafer surface.

FIG. 14 is a plan view showing the areas shown in FIG. 13. Though the illumination areas 20, 55, 56 exist on the same θ coordinate actually, the beam position is shown deviated in the θ direction in FIG. 14 for the sake of description. When variations in the wafer height occurs, observation of parts around an irradiated area from a direction perpendicular to the wafer 1 reveals that the illumination areas are observed to deviate in the R direction. At this time, a relationship expressed by the following expression holds between a positional deviation of illumination area D and a magnitude of variations in wafer height h.

D=h/cos θi (Expression 1)

This means that the smaller the illumination elevation angle θi relative to the wafer 1, the greater the positional deviation of illumination area D when variations in wafer height occurs. Roughness scattered light is emanated from the illumination areas 20, 55, 56 and the illumination area observing optical system 105 is used to detect the roughness scattered light. This allows the positional deviation of illumination area D as a result of the variations in wafer height to be detected. Use of (expression 1) allows the magnitude of variations in wafer height h and the direction of variations, either upper or lower, to be calculated from the positional deviation of illumination area D.

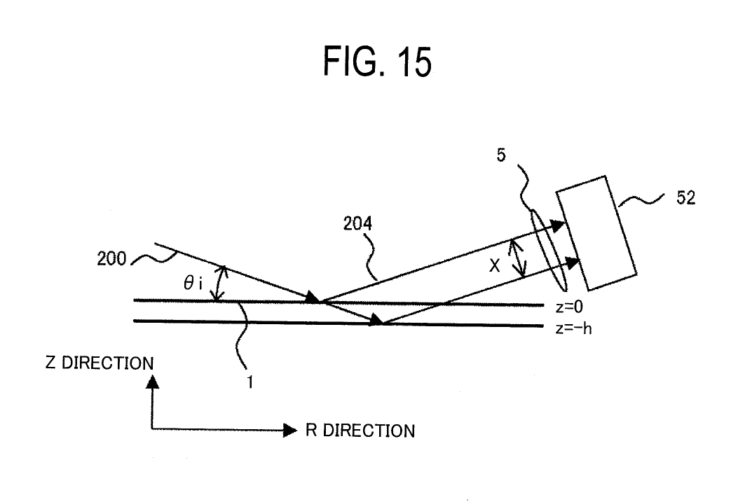

The technique of (2) above will be described below with reference to FIG. 15.

FIG. 15 is an enlarged side elevational view showing an area in which a regularly reflected light 204 from the laser beam 200 that enters the wafer 1 at an elevation angle θi in FIG. 12 enters a PSD 52. FIG. 14 shows a case in which the wafer surface height varies only by z=−h μm. When the wafer surface height varies as shown in FIG. 14, the position at which the regularly reflected light enters the PSD 52 changes. The PSD 52 outputs an electric signal corresponding to the position on which the regularly reflected light is incident. Consequently, how much the position on which the regularly reflected light is incident is deviated by the variations in wafer height can be detected with reference to the position on which the regularly reflected light 204 is incident when the wafer surface height is z=0. Let X be the magnitude of deviation in the regularly reflected light detected position output from the PSD 52. Then, the following relationship holds.

X=2·h·cos θi (Expression 2)

The magnitude X of deviation in the detected position of the regularly reflected light 204 from the wafer 1 is detected using the regularly reflected light observing optical system 106 and the magnitude of variations in wafer height h and the direction of variations, either upper or lower, can be calculated using (expression 2).

(Processing in the Signal Processing System 104)

The signal processing system 104 shown in FIG. 12 is configured substantially similarly to the signal processing system 104 of the defect inspection apparatus shown in FIG. 1. The signal processing system 104 shown in FIG. 12, however, differs from the signal processing system 104 of the defect inspection apparatus shown in FIG. 1 in that the magnitude of variations in wafer height and the direction of variations detected by either the illumination area observing optical system 105 or the regularly reflected light observing optical system 106 is input to a pixel shift detecting section 152. The magnitude of pixel shift and the direction of pixel shift can be calculated geometrically using a trigonometric function, and the azimuth direction φ, the elevation angle direction θs, and the magnitude of variations in wafer height h. A magnitude of pixel shift P is as follows.

P=h·sin θs/tan φ (Expression 3)

The pixel shift detecting section 152 calculates the magnitude of pixel shift and the direction of pixel shift for each detection optical system based on (expression 3) and using the parameters of the azimuth θ, the elevation angle θs, and the magnitude of variations in wafer height h. The pixel shift detecting section 152 then generates a pixel shift correction signal and outputs the signal to a pixel shift correcting section 153.

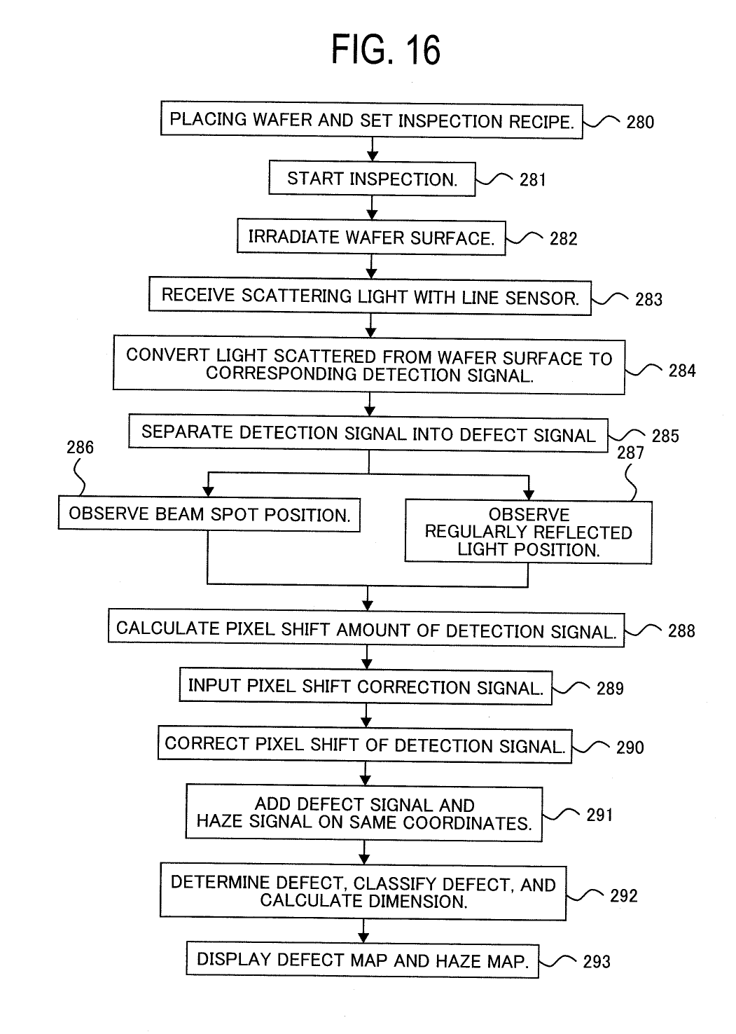

A defect detection process will be described below with reference to FIG. 16. The wafer 1 is first placed on the stage and an inspection recipe is set (step 280). The inspection is started (step 281) and the surface of the wafer is irradiated with light (step 282). Light scattered from the wafer surface is received by the line sensor (step 283) and the light scattered from the wafer surface is converted to a corresponding detection signal (step 284). The converted detection signal is separated into a defect signal obtained from light scattered from a defect on the wafer surface and a haze signal obtained from light scattered from irregularities on the wafer surface (step 285). The illumination area observing optical system 105 observes the position of the illumination area and the magnitude and the direction of variations in wafer height are thereby detected (step 286). Or, the regularly reflected light observing optical system 106 observes the position of regularly reflected light and the magnitude and the direction of variations in wafer height are thereby detected (step 287). Based on the magnitude and the direction of variations in wafer height detected with means of either step 286 or step 287, the magnitude of pixel shift and the direction of pixel shift for each detector is calculated (step 288). A pixel shift correction signal for each detector is then transmitted based on a pixel shift amount obtained through calculation (step 289). The pixel shift correcting section 153 corrects the detection signal for pixel shift based on the pixel shift correction signal (step 290). A signal adding and defect determining section 154 adds up signals of identical coordinates (step 291). The defect is then determined and classified, dimensions are calculated, and haze processing is performed based on the added signal (step 292). A defect map and a haze map are displayed (step 293).

Here again, in the same manner as in the first embodiment, when the signals of the identical coordinates are to be added, a plurality of detection signals based on scattered light obtained by irradiating a substantially identical area on the wafer surface a plurality of times may be added, or a plurality of detection signals based on scattered light received by the detection optical systems disposed at different azimuth directions relative to the wafer surface may be added. When all of these detection signals are added up, a significant signal amplification effect can be obtained. Furthermore, the defect detection may be made using the detection signal in which the pixel shift is corrected for a single detection signal. In this case, the pixel shift amount is corrected and the position of the defect can be accurately detected.

FIG. 12 has been described for a case in which only one optical system which obliquely illuminates a wafer from a low elevation angle θi and only one detection optical system are existing. Nonetheless, a vertical illumination optical system illuminating the wafer from a substantially perpendicular direction may exist. The embodiment has been described for an example in which only the detection optical system 102 disposed at a detection elevation angle θs exists. A plurality of detection optical systems disposed at a plurality of detection elevation angles θs may nonetheless be disposed. In addition, no restrictions are imposed on the elevation angles and the value of the numerical aperture of the multiple detection optical systems. The detection optical system 102 includes a plurality of detection optical systems, each detection optical system being disposed at a unique azimuth direction φ as shown in FIG. 1. However, these detection optical systems are not necessarily disposed at substantially the same elevation angle, or each does not necessarily have a unique elevation angle. No restrictions are imposed on the azimuth at which each is disposed. A CCD camera 51 is used to receive roughness scattered light for photoelectric conversion. An I-CCD (intensified CCD), an EM-CCD (electron multiplying CCD), an EB-CCD (electron bombardment CCD), a two-dimensional multi-anode photomultiplier tube, a two-dimensional avalanche photodiode array, or a high sensitivity sensor combining an image intensifier with an area sensor may be used. Since the scattered light emanated from surface roughness is extremely feeble, the embodiment is advantageous in that use of a highly sensitive sensor allows the roughness scattered light from a wafer with minor surface roughness to be detected. Further, any model may be used for the CCD camera 51.

FIG. 12 shows a configuration including both the illumination area observing optical system 105 and the regularly reflected light observing optical system 106. However, the defect detection process shown in FIG. 16 can be performed as long as at least one of the abovementioned two optical systems.

The embodiment has been described for a case in which the illumination area observing optical system 105 or the regularly reflected light observing optical system 106 is used to detect the magnitude and the direction of variations in wafer height. However, as explained below, instead of using the line sensor 13, an area sensor may be used to detect the magnitude and the direction of variations in wafer height.

Consider a case in which the detection optical system 102 is disposed at a detection azimuth φ of about 90 degrees and an area sensor is used for a photoelectric conversion element of the detection optical system 102. For the area sensor, model 58665-0909 manufactured by Hamamatsu Photonics K.K., for example, may be used. The model S8665-0909 has 512-by-512 pixels and a pixel size of 24 by 24 μm.

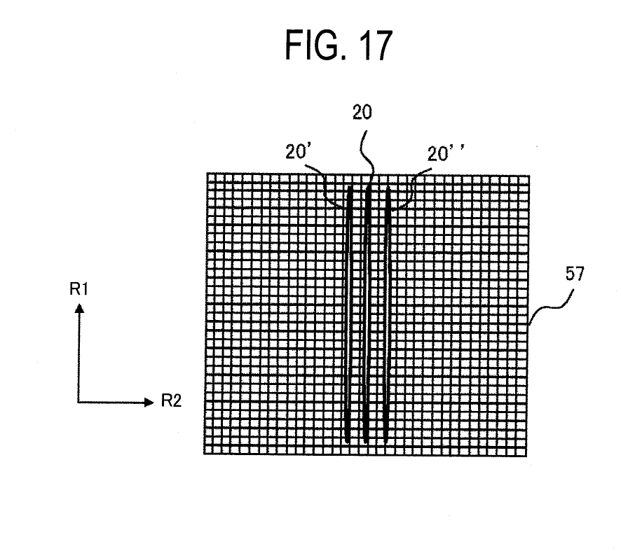

FIG. 17 shows a positional relationship between the illumination area 20 on the wafer surface and a detection area 57 of the area sensor. The figure shows that, when the height of the wafer surface deviates to z=h as a result of variations in the wafer height, the illumination area 20 deviates to a position of an illumination area 20′, while when the height of the wafer surface deviates to z=−h, the illumination area 20 deviates to a position of an illumination area 20″. When the illumination area 20 deviates as a result of variations in the wafer height, the pixel for detecting light scattered from the illumination area deviates. The magnitude and the direction of variations in wafer height can therefore be detected based on deviation in the detecting pixel.

Following specific examples are possible. If illumination is performed having one, or two or more peak values of illuminance as in a Gaussian distribution, the magnitude and the direction of variations in wafer height can be detected based on movement of the pixel which detects the greatest light intensity. In addition, for an R2 axis, a center of gravity of illumination intensity may be obtained to thereby detect the magnitude and the direction of variations in wafer height based on the number of pixels moved.

If illumination is performed with a uniform illuminance distribution, the magnitude and the direction of variations in wafer height can be detected based on the number of pixels moved at the center of the illumination area relative to the R2 axis.

The second embodiment has been described for a case in which the magnitude of pixel shift and the direction of pixel shift are calculated based on the magnitude and the direction of variations in wafer height and coordinate corrections are thereby made. However, as shown in the first embodiment, instead of the pixel shift correction signal, an adding pixel correction signal may be generated and, based on the adding pixel correction signal, the pixels to be added up may be corrected.

### Third Embodiment

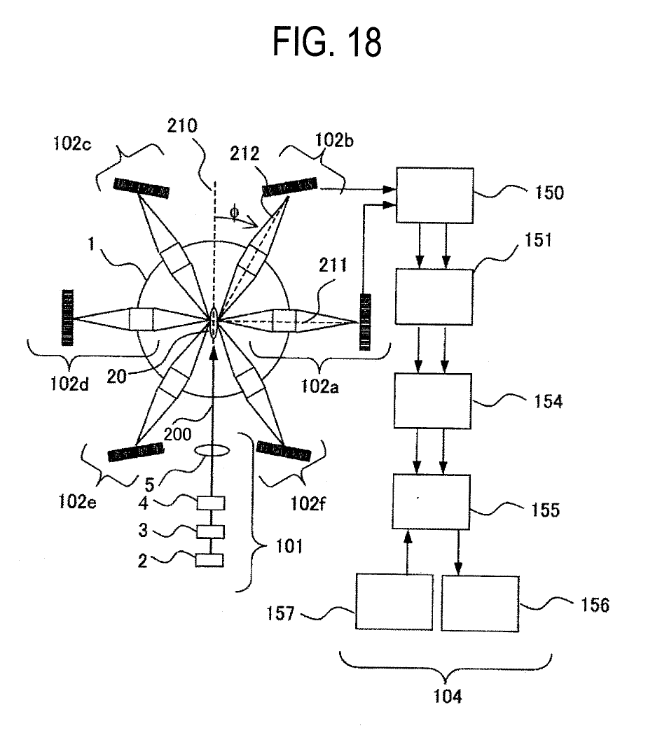

A third embodiment of the present invention will be described below with reference to FIG. 18. An illumination optical system 101, a detection optical system 102, and a wafer stage 103 has substantially similar arrangements as those shown in FIGS. 1A and 1B and descriptions thereof will not be duplicated.

It has been described with reference to the first embodiment that, in the detection optical system 102a in which the longitudinal direction 210 of the illumination area 20 and the optical axis 211 substantially form an angle of 90 degrees therebetween, no pixel shift occurs even with variations in height of the wafer. Meanwhile, in the detection optical system 102b in which the longitudinal direction 210 of the illumination area and the optical axis 212 do not substantially form an angle of 90 degrees therebetween, pixel shift occurs with variations in height of the wafer.

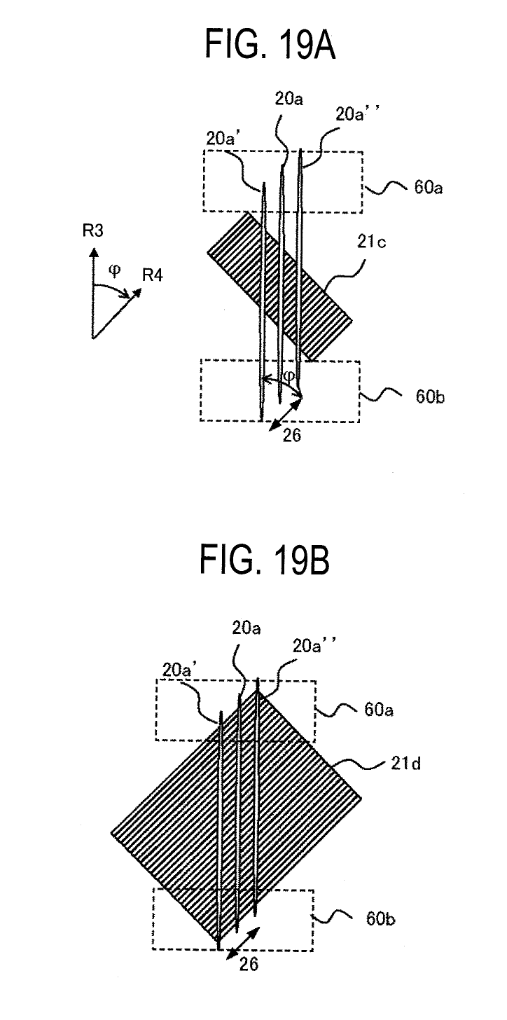

The pixel shift can, however, be avoided from occurring by rotating the line sensor about the optical axis of the detection optical system to thereby make the direction 26 in which the illumination area 20 deviates as a result of variations in height of the wafer substantially coincide with the pixel height direction. FIGS. 19A and 19B show positional relationships between an illumination area 20a on the wafer surface and detection ranges 21c, 21d of the detection optical system 102b. FIGS. 19A and 19B show that, if the wafer surface height deviates by +h μm in the z direction, the illumination area 20a deviates to a position of an illumination area 20a′ and, if the wafer surface height deviates by −h μm in the z direction, the illumination area 20a deviates to a position of an illumination area 20a″. The longitudinal direction 210 of illumination is here defined as an R3 axis.

Let ψ be an angle formed between the R3 axis and the direction 26 in which the illumination area 20 deviates as a result of variations in height of the wafer. Then, the following relationship holds, not dependent on the detection elevation angle.

ψ=φ

The height direction of the pixel of the line sensor is here defined as an R4 axis. By rotating the line sensor until the angle formed between the R3 and the R4 is ψ, the direction 26 in which the illumination area deviates as a result of variations in height of the wafer can be made to substantially coincide with the pixel height direction, thereby preventing pixel shift from occurring. Since the magnitude of ψ varies depending on the azimuth φ at which the detection optical system is disposed, the angle through which the line sensor is to be rotated is set for each detection optical system. In the condition shown in FIG. 19A, however, since no parts in areas 60a, 60b and in the detection range 21c of the line sensor cross each other, light scattered from a defect as the defect moves across the areas 60a, 60b cannot be detected, resulting in failure to detect the defect. In order of avoid the failure to detect defects, it is necessary to use a line sensor with a high pixel height or to make the optical magnification small only in the pixel height direction. Use of either approach allows the detection range 21d shown in FIG. 19B to be created with the line sensor. The above approach allows the scattered light to be detected even if the defect moves across the areas 60a, 60b. The pixel shift occurring from the variations in height of the wafer and failure to detect defects can both be avoided.

An anamorphic optical system, for example, may be used to change the optical magnification only in the pixel height direction.

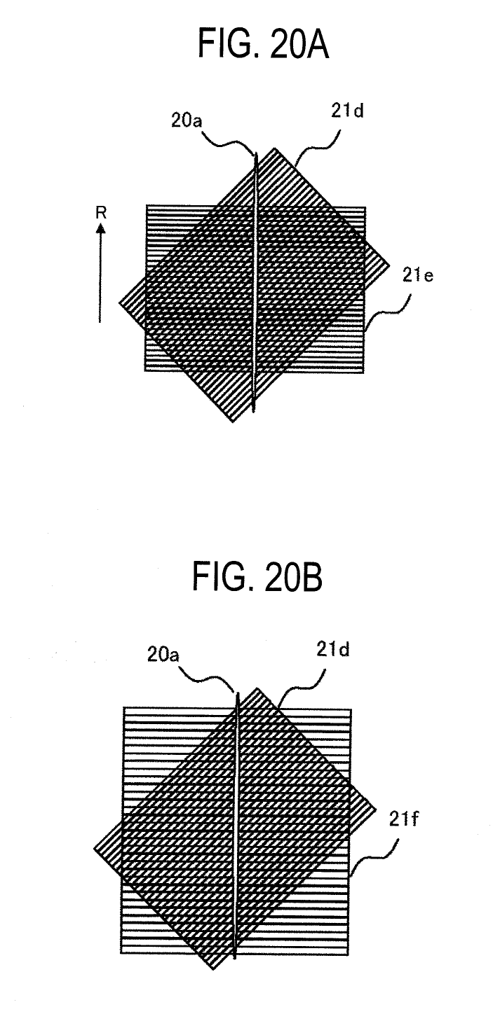

FIG. 20A shows a positional relationship among the illumination area 20 on the wafer, a detection range 21e of the detection optical system 102a, and the detection range 21d of the detection optical system 102b. The positional relationship represents a condition in which, for both the detection optical systems 102a and 102b, the pixel height direction is optically reduced by the same magnification and the line sensor of the detection optical system 102b is rotated only by ψ as shown in FIG. 18 so as to prevent pixel shift from occurring.

The figure shows that the above adjustment prevents pixel shift from occurring both in the detection optical systems 102a and 102b, but the detection range 21d and the detection range 21e on the wafer surface differ in size from each other. The detection range 21d has a detection area per pixel that is “1/sin ψ” times as large as that of the detection range 21e, which makes it difficult to add up readings of scattered light emanated from a substantially identical area. For this, the magnification of the detection optical system 102a has only to be set to “sin ψ” times relative to the detection optical system 102b, so that the detection ranges substantially coincide with each other. In FIG. 20B, the magnification of the detection optical system 102a is reduced to “sin ψ” times to thereby achieve coincidence with the detection range 21d of the detection optical system 102b, thus establishing a condition in which pixel shift and failure to detect defects can be avoided.

To make the detection range 21e coincide with the detection range 21f, the optical magnification of the detection optical system 102b may be set to “1/sin ψ” times. A signal processing system 104 of this embodiment does not include a pixel shift detection section or a pixel shift correcting section. This is because of the following reason. Specifically, the rotation of the line sensor about the optical axis of the detection optical system allows occurrence of the pixel shift to be avoided, which eliminates the need for handling the pixel shift in the signal processing system.

In FIG. 18, the embodiment has been described to include six detection optical systems disposed at different azimuth directions φ. The azimuth directions are not necessarily six. The magnitude of the azimuth between detectors is not restricted, either. Similarly, no restrictions are imposed on the illumination elevation angle and elevation angle directions in which the detection optical systems are disposed.

As described above, in this embodiment of the present invention, pattern matching using the haze signal detected by each detection optical system is performed to thereby detect the magnitude of pixel shift and the direction of pixel shift, and coordinates of the detection signal are corrected based on the magnitude of pixel shift and the direction of pixel shift to thereby enable accurate addition of scattered light signals produced from a substantially identical area.

The magnitude and direction of variations in height of the wafer are detected by monitoring positional deviation of the illumination area or the regularly reflected light of the laser beam with which the wafer is irradiated and coordinates of the detection signal is corrected based on the signal. The scattered light signals produced from a substantially identical area can thereby added up accurately.

The line sensor is rotated about the optical axis according to the azimuth φ at which the detection optical system is disposed and the optical magnification of the detection optical system is adjusted according to the azimuth φ. Occurrence of pixel shift as a result of variations in height of the wafer can thereby be avoided. In the above-described embodiments, the wafer is exemplified for the object to be inspected; however, any samples other than the wafer may be used as sampled from, for example, semiconductor substrates and thin film substrates. In addition, the line sensor capable of detecting a plurality of pixels is exemplified for the detection optical system. Nonetheless, any detector capable of detecting a plurality of pixels may be used, including an area sensor.

The aspect of the present invention can provide a defect inspection method and a defect inspection apparatus for inspecting a defect present on the surface of a sample with high accuracy.

The invention made by the inventor has been described in detail based on embodiments thereof; however, it is to be understood that the present invention is not limited to those embodiments and various changes in form and detail may be made therein without departing from the spirit and scope of the invention.

### DESCRIPTION OF REFERENCE NUMERALS

1: Wafer
2: Laser light source
3: Beam expander
4: Polarizing element
m: Mirror
5: Condenser lens
6: Rotational stage
7: Translational stage
10: Objective lens
11: Polarizing element
12: Imaging lens
13: Line sensor
15, 16: Plane
20, 20′, 20″, 55, 56: Illumination area
17, 21a to 21f: Detection range of line sensor on wafer surface
25, 26, 27: Direction the illumination area deviates as a result of variations in height of the wafer
30a, 30b: Haze signal
40: Birefringent element
41: Illuminance distribution
42, 45: Haze signal
43: Mask
44: Modulated illumination area
50: Microscope unit
51: CCD camera
52: PSD
57: Detection range of area sensor on wafer surface
60a, 60b: Inspection area
101: Illumination optical system
102, 102a to 102h: Detection optical system
103: Wafer stage
104: Signal processing system
105: Illumination area observing optical system
106: Regularly reflected light observing optical system
150: Analog circuit
151: A/D converting section
152: Pixel shift detecting section
153: Pixel shift correcting section
154: Signal adding and defect determining section
155: CPU
156: Map output section
157: Input section
160: Defect map
161: Haze map
170 to 189: Inspection process
200 to 203: Laser beam
204: Regularly reflected light
210: Longitudinal direction of illumination
211, 212: Optical axis of detection optical system
213: Direction in which pixels of line sensor are arrayed

1. A method for inspecting a defect on a surface of a sample, comprising the steps of:
irradiating a sample surface with illumination light, with the sample surface being formed with an elliptically shaped illumination area upon irradiation;
receiving light scattered from the sample surface using a detector having a plurality of pixels, the detector being disposed corresponding to the illumination area and capable of detecting scattered light with the plurality of pixels;
converting the scattered light received by the detector into a corresponding detection signal;
extracting from the detection signal a haze signal obtained from scattered light emanated from irregularities on the sample surface irradiated with the illumination light;
calculating a pixel shift amount based on a distribution of the haze signal; and
detecting a defect by processing the detection signal after correcting the detection signal using the pixel shift amount.

2. A method for inspecting a defect on a surface of a sample, comprising the steps of:
irradiating a predetermined area on a sample surface with illumination light plural times, with the sample surface being formed with an elliptically shaped illumination area upon irradiation;
receiving light scattered from the sample surface in each irradiation sequence using a detector having a plurality of pixels, the detector being disposed corresponding to the illumination area and capable of detecting scattered light with the plurality of pixels;
converting the scattered light from the sample surface in each time of the irradiation into a corresponding detection signal in each time of the irradiation and extracting from each of the detection signals obtained in the converting step a haze signal obtained from scattered light which is emanated from irregularities on the sample surface irradiated with the illumination light;
calculating a pixel shift amount for each of the multiple detection signals by comparing a distribution of a plurality of haze signals extracted from the extracting step with a predetermined light intensity distribution;
correcting the detection signals using the pixel shift amount calculated for each of the detection signals; and
detecting a defect from the detection signal by adding up the multiple detection signals corrected in the correcting step.

3. The defect inspection method according to claim 2, wherein:
in the step of calculating the pixel shift amount, the distribution of the multiple haze signals is compared with a reference light intensity distribution that is a distribution of haze signals obtained when the illumination light is irradiated in an assumed condition of no variations in a direction perpendicular to the sample surface.

4. The defect inspection method according to claim 2, wherein in the step of receiving the scattered light, the scattered light is received by a plurality of detectors disposed in a plurality of azimuth directions relative to the sample surface.

5. The defect inspection method according to claim 4, wherein in the step of calculating the pixel shift amount, the distribution of the multiple haze signals is compared with a distribution of a haze signal obtained from scattered light received by one detector selected from among the multiple detectors.

6. The defect inspection method according to claim 5, wherein the one selected detector is disposed such that an optical axis of scattered light to be detected by the one detector extends in a direction substantially orthogonal to a longitudinal direction of the illumination area.

7. The defect inspection method according to claim 4, wherein in the step of detecting a defect, the defect is detected by adding up all detection signals of the multiple detectors.

8. The defect inspection method according to claim 4, wherein in the step of detecting a defect, the defect is detected using detection signals of some detectors selected from among the multiple detectors.

9. The defect inspection method according to claim 2, wherein in the step of calculating the pixel shift amount, the pixel shift amount is calculated for each of the multiple detection signals by comparing a pixel that takes a maximum value for each of the distribution of the multiple haze signals with a pixel that takes a maximum value of the predetermined light intensity distribution.

10. A method for inspecting a defect on a surface of a sample, comprising the steps of:
irradiating a sample surface with illumination light, with the sample surface being formed with an elliptically shaped illumination area upon irradiation;
receiving light from the sample surface using a detector, the detector being disposed corresponding to the illumination area and capable of detecting light of a plurality of pixels;
converting the light received by the detector into a corresponding detection signal; and
detecting a defect by correcting the detection signal such that a pixel shift amount is reduced.

11. An apparatus for inspecting a defect on a surface of a sample, comprising:
an illumination optical system for irradiating a predetermined area on a sample surface with illumination light, with the sample surface being formed with an elliptically shaped illumination area upon irradiation;
a detection optical system including:
a detector having a plurality of pixels and capable of detecting light scattered from the sample surface, the scattered light originating from the illumination light of the illumination optical system; and
a converting circuit for converting the scattered light detected with the detector into a corresponding detection signal; and
a signal processing system including:
a pixel shift amount detecting section for calculating a pixel shift amount of the detection signal by extracting from the detection signal a haze signal obtained from scattered light emanated from irregularities on the sample surface irradiated with the illumination light from the illumination optical system and comparing a distribution of the haze signal with a predetermined light intensity distribution; and
a defect determining section for detecting a defect by processing the detected signal after correcting the detection signal based on the pixel shift amount.

12. The defect inspection apparatus according to claim 11, wherein the pixel shift amount detecting section uses a reference light intensity distribution as the predetermined light intensity distribution, the reference light intensity distribution being a distribution of haze signals obtained when the illumination light is irradiated in an assumed condition of no variations in a direction perpendicular to the sample surface.

13. The defect inspection apparatus according to claim 11, wherein the detection optical system includes a plurality of detectors disposed at a plurality of azimuth directions relative to the sample surface.

14. The defect inspection apparatus according to claim 13, wherein the predetermined light intensity distribution is a distribution of a haze signal obtained from scattered light received by one detector selected from among the multiple detectors.

15. The defect inspection apparatus according to claim 14, wherein the one selected detector is disposed such that an optical axis of scattered light to be detected by the one detector extends in a direction substantially orthogonal to a longitudinal direction of the illumination area.

16. The defect inspection apparatus according to claim 13, wherein the defect determining section detects a defect by adding up all detection signals corrected based on the pixel shift amount, of the multiple detectors.

17. The defect inspection apparatus according to claim 13, wherein the defect determining section detects a defect using detection signals corrected based on the pixel shift amount, of some detectors selected from among the multiple detectors.

18. The defect inspection apparatus according to claim 11, wherein the pixel shift amount detecting section calculates the pixel shift amount for each of the multiple detection signals by comparing a pixel that takes a maximum value for each of the distribution of the multiple haze signals with a pixel that takes a maximum value of the predetermined light intensity distribution.
